(19) United States
(12) Patent Application Publication
(10) Pub. No.: US 2007/0186360 A1
(43) Pub. Date: Aug. 16, 2007

(54) Bahl masterscraper

(76) Inventor: John Andrew Bahl JR., Aurora, IL (US)

Correspondence Address: John A. Bahl, Jr., 816 Lebanon, Aurora, IL, 60505, US

(21) Appl. No.: 11/355,226

(22) Filed: Feb. 16, 2006

(51) Int. Cl. B08B 9/38; A63B 53/00

(52) U.S. Cl. 15/93.1; 473/282

(57) ABSTRACT

A 3 inch scraper on a golf club shaft.

### FIELD OF THE INVENTION

The present invention relates to and, more particularly, to Custodial/Janitorial assistance in schools, industrial settings, gymnasium floors, cafeterias and any large public arenas.

### BACKGROUND OF THE INVENTION

While a school custodian is sweeping/dusting the floors he comes upon a piece of gum stuck on the floor. There are spit balls on the walls and ceiling that need scraped down as well. The custodian may also find a pencil stuck in the ceiling tile. The custodian must stop what he is doing to take care of his findings. With the Masterscraper, the custodian just pulls off the long handled scraper, scrapes up the object, then continues his job without bending over or climbing on chairs or ladders.

Currently most custodians carry scrapers in their back pockets.

With the current process the custodian has to bend over to scrape up the gum, or climb a ladder to scrape the spit balls off the walls and ceilings. The extra bending and climbing risk injuries to the custodian and takes away precious time from his job.

It is therefore an object of the invention to aid maintenance workers at scraping up gum and such stuck on floors, walls and ceilings.

It is another object of the invention to aid in scraping paint from out of reach areas.

It is another object of the invention to eliminate work related injuries from bending over and climbing ladders, risking falls.

It is another object of the invention to expedite time.

### SUMMARY OF THE INVENTION

A 3 inch scraper blade attached to a golf club shaft with a two handed grip.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of the bahl masterscraper is a 3 inch scraper blade attached to a golf club shaft.

For purposes of clarity and brevity, like elements and components will bear the same designations and numbering throughout the Figures.

### DESCRIPTION OF THE PREFERRED EMBODIMENT

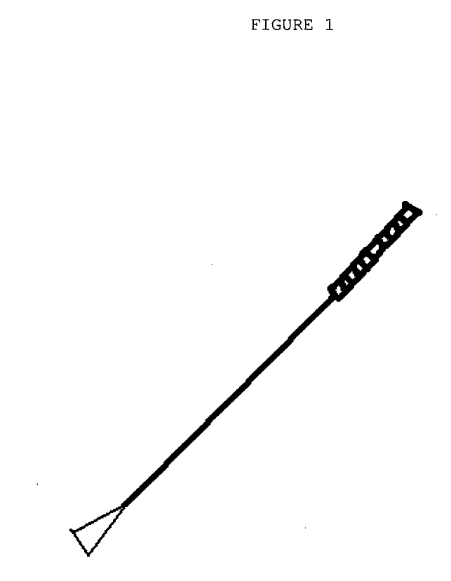

FIG. 1 is a front view of the bahl masterscraper is a 3 inch scraper blade attached to a golf club shaft.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A bahl masterscraper for bahl masterscraper, comprising:
means for ease of scraping.

2. The bahl masterscraper in accordance with claim 1, wherein said means for ease of scraping comprises a scraper on a golf club shaft.

3. A bahl masterscraper for bahl masterscraper, comprising:
a scraper on a golf club shaft, for ease of scraping.
